(19) United States
(12) Patent Application Publication
(10) Pub. No.: US 2026/0062589 A1
(43) Pub. Date: Mar. 5, 2026

(54) UTILIZATION OF PETROLEUM COKE (PETCOKE) IN ASPHALT

(71) Applicant: Saudi Arabian Oil Company, Dhahran (SA)

(72) Inventors: Mohammed Al Mehthel, Dhahran (SA); Nawaf Abdulrahman Alubaidi, Dhahran (SA); Sami A. Al Abduljabbar, Dhahran (SA)

(21) Appl. No.: 18/819,466

(22) Filed: Aug. 29, 2024

(51) Int. Cl. C09D 195/00; C09D 7/40; C09D 7/61; C09D 7/65; C10C 3/00

(52) U.S. Cl. CPC C09D 195/00; C09D 7/61; C09D 7/65; C09D 7/68; C09D 7/69; C09D 7/70; C10C 3/005

(57) ABSTRACT

The disclosure relates to a petroleum coke-containing asphalt composition and a method paving a surface using the petroleum coke-containing asphalt composition. A petroleum coke-containing roof coating composition and a method of treating a building surface using the petroleum coke-containing roof coating composition are also disclosed.

### TECHNICAL FIELD

The present disclosure relates to asphalt compositions containing petroleum coke. The present disclosure also relates to methods of producing asphalt products with petroleum coke for application in asphalt paving in highways and roads, asphalt roofing, water-proofing and damp-proofing products.

### BACKGROUND

Petroleum coke is a byproduct of the oil refining process and has traditionally been limited in its applications. Despite its high carbon content and potential for industrial uses as a source of energy, the utilization of petroleum coke has been restricted due to challenges in optimizing its properties for different applications.

Petroleum coke has faced barriers in its broader adoption. Its physical and chemical characteristics have posed difficulties in processing and integration into other materials.

Additionally, environmental concerns associated with its combustion and the release of pollutants have further constrained its use. Consequently, there has been a need to develop alternative methods and compositions that can effectively utilize petroleum coke while mitigating its limitations.

### SUMMARY

In one exemplary embodiment, an asphalt composition is provided. The asphalt composition includes a filler in an amount of about 1 to about 15 wt. % of the asphalt composition, a binder in an amount of about 2 to about 10 wt. % of the asphalt composition, a fine aggregate (FA) in an amount of about 20 to about 90 wt. % of the asphalt composition, a coarse aggregate (CA) in an amount of about 20 to about 90 wt. % of the asphalt composition, and a petroleum coke in an amount of about 0.1 to about 5 wt. % of the asphalt composition.

In some embodiments, the petroleum coke has a particle size in a range of about 0.1 micrometers (μm) to about 50 millimeters (mm).

In some embodiments, the petroleum coke has a particle size at 80% cumulative passing (D80) of equal to or less than about 45 μm.

In some embodiments, the petroleum coke comprises about 80 to 95 wt. % of carbon, about 0.1 to 10 wt. % of sulfur, about 2 to 5 wt. % of hydrogen, about 0.1 to 1 wt. % of nitrogen, about 0.1 to 10 wt. % of moisture, about 0.1 to 5 wt. % of ash, about 0.1 to 10 wt. % of two or more volatile organic compounds, and 0.1 to 5 wt. % of two or more metals.

In some embodiments, the two or more metals are selected from the group consisting of aluminum, calcium, chromium, cobalt, iron, manganese, magnesium, molybdenum, nickel, potassium, sodium, titanium, vanadium, copper, zinc, lead, tin, silver, gold, platinum, palladium, beryllium, and cadmium.

In some embodiments, the petroleum coke has a density in a range of about 1 to about 1.7 kilograms per cubic meter (kg/m³), and a Mohs hardness in a range of about 5 to about 8.

In some embodiments, the filler is selected from the group consisting of a cementitious material, a limestone powder material, a pozzolanic material, a lime material, an oil ash material, a recycled plastic material, a rubber material, a fly ash material, a fiber reinforced polymer (FRP) composite material, and mixtures thereof.

In some embodiments, the cementitious material is selected from the group consisting of portland cement, pozzolan cement, gypsum cement, aluminous cement, silica cement, alkaline cement, and cement dust.

In some embodiments, the recycled plastic material is selected from the group consisting of very low density polyethylene (VLDPE), linear low density polyethylene (LLDPE), low density polyethylene (LDPE), medium density polyethylene (MDPE), high density polyethylene (HDPE), and polycarbonate.

In some embodiments, the FRP composite material contains a fiber selected from the group consisting of a polypropylene, a polyethylene, an asbestos, a rock wool, a polyester, natural cellulose fibers, mineral fibers, and mixtures thereof.

In some embodiments, the binder is selected from the group consisting of bitumen, sulfur extended asphalt, polymer modified asphalt, rubber modified asphalt, and recycled plastic modified asphalt.

In some embodiments, the FA is sand.

In some embodiments, the CA is selected from the group consisting of crushed stone, crushed gravel, and mixtures thereof.

In some embodiments, the asphalt composition further contains one or more of an anti-stripping agent, an anti-rutting agent, an antioxidant, a stabilizer, an adhesion promoter, and a polymer modifier.

In another exemplary embodiment, a method for paving a surface includes heating and mixing a filler, a fine aggregate, a coarse aggregate, and a petroleum coke at a temperature of about 140 to about 180° C. to form a heated composition. The method further includes mixing a binder with the heated composition for about 60 seconds (s) to form the asphalt composition. The method further includes applying the asphalt composition onto the surface, and compacting the asphalt composition applied. In some embodiments, the surface is a road surface. In some embodiments, the applying is performed by spreading the asphalt composition to cover at least a portion of the surface. In some embodiments, the compacting the asphalt composition is performed by applying a pressure onto the asphalt composition applied. The method for paving the surface further includes loading the asphalt composition into a transport container of a vehicle, and transporting the asphalt composition to a construction site.

In another exemplary embodiment, a roof coating/water-proofing/damp-proofing composition is provided. In some embodiments, the roof coating composition contains a filler in an amount of about 0.01 to about 60 wt. % of the roof coating composition, a binder in an amount of about 40 to about 95 wt. % of the roof coating composition, and a petroleum coke in an amount of about 2 to about 65 wt. % of the roof coating composition.

In some embodiments, the roof coating/water-proofing/damp-proofing composition further contains one or more of about 0.01 to about 10 wt. % of an anti-stripping agent, about 0.01 to about 10 wt. % of an anti-rutting agent, about 0.01 to about 5 wt. % of an antioxidant, about 0.01 to about 5 wt. % of a stabilizer, about 0.01 to about 5 wt. % of an adhesion promoter, and about 0.01 to about 10 wt. % of a polymer modifier.

In some embodiments, the roof coating/water-proofing/damp-proofing composition is a hot mix that include only the binder, such as bitumen, and the filler. In some embodiments, the filler is the petroleum coke or a partial replacement of a filler, such as calcium carbonate and/or cement, with the petroleum coke.

In some embodiments, a roofing product made from the roof coating/water-proofing/damp-proofing composition is made in the form of a membrane that can be fixed to a surface with one or more adhesive materials or with one or more mechanical fixing mechanisms.

In some embodiments, the roofing product is made as a shingle in the presence of a framework.

In another exemplary embodiment, a method of treating an object surface includes mixing and heating a filler and a petroleum coke at a temperature of about 140 to about 180° C. to form a mixture. The method further includes mixing a binder with the mixture to form a roof coating composition. The method further includes applying the roof coating composition to the object surface.

In some embodiments, the object surface is a roof surface. In some embodiments, the roof surface is made of at least one material selected from the group consisting of an asphalt-based material, a clay-based material, a metal-based material, a wood-based material, a cementitious material, and a polymer-based material.

### BRIEF DESCRIPTION OF THE DRAWINGS

FIG. 1 is a flow chart depicting a method for paving a surface, according to certain embodiments of the present disclosure.

FIG. 2 is a flow chart depicting a method of treating an object surface, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “particle size” and “grain size” are thought of as the lengths or longest dimensions of a particle and of a pore opening, respectively.

As used herein, the terms “room temperature” and “ambient temperature” refer to a temperature in a range of 25 degrees Celsius (° C.)+3° C.

As used herein, the term “atmospheric pressure” refers to the pressure exerted by the weight of air in the atmosphere of Earth. The standard atmosphere is a unit of pressure defined as about 101325 Pa (or about 1.01325 bar), equivalent to about 760 mmHg (torr), or about 29.92 in Hg and about 14.696 psi in the present disclosure.

As used herein, the term “uniform shape” refers to an average consistent shape that differs by no more than about 10%, such as by no more than about 5%, by no more than about 4%, by no more than about 3%, by no more than about 2%, or by no more than about 1% of the distribution of particles having a different shape.

As used herein, the term “non-uniform shape” refers to an average consistent shape that differs by more than about 10%, such as more than about 15%, more than about 20%, or more than about 30% of the distribution of particles having a different shape.

As used herein, the term “portland cement” generally refers to the most common type of cement in general use developed from types of hydraulic lime and usually originating from limestone. It is a fine powder produced by heating materials in a kiln to form what is called clinker, grinding the clinker, and adding small amounts of other materials. The portland cement is made by heating limestone (calcium carbonate) with other materials (such as clay) to >1400° C. This process in a kiln is also known as calcination, whereby a molecule of carbon dioxide is liberated from the calcium carbonate to form calcium oxide, or quicklime, which is then blended with the other materials that have been included in the mix to from calcium silicates and other cementitious compounds. The resulting hard substance, called “clinker” is then ground with a small amount of gypsum into a powder to make ordinary portland cement. Several types of portland cement are available with the most common being called ordinary portland cement which is grey in color.

As used herein, the term “binder” generally refers to a highly viscous liquid or semi-solid form of petroleum. In the present disclosure, the term “binder” may include, for example, bitumen, sulfur extended asphalt, polymer modified asphalt, rubber modified asphalt, and recycled plastic modified asphalt.

As used herein, the term “bitumen” generally refers to a class of black or dark-colored (solid, semisolid, or viscous) cementitious substances, natural or manufactured, composed principally of high molecular weight hydrocarbons, of which asphalts, tars, pitches, and asphaltenes are typical. Examples of bitumen that may be used in the compositions and methods of the present disclosure include natural bitumen, pyrobitumens, and artificial bitumen.

As used herein, the term “asphalt” generally refers to a bituminous material that may be used to pave roads or other surfaces or used in other construction materials such as roofing materials, coatings, and water sealants. In some examples, the asphalt of the present disclosure is blended or “cut back” with a volatile substance, resulting in a product that is soft and workable at a lower temperature than pure asphalt. When the cut-back asphalt is used for paving or construction, the volatile cutter solvent evaporates when exposed to air or heat, leaving hardened asphalt behind. The volatility of the cutting solvent classifies the cutback asphalt as slow, medium, or rapid-curing asphalt. For example, heated asphalt that is mixed with residual asphaltic oil from an earlier distillation process is described as slow-curing asphalt. Asphalt including blends of gasoline or naphtha is described as medium-curing asphalt, and asphalt including blends of kerosene is described as rapid-curing asphalt. In further examples, the asphalt may be oxidized when used in roofing, pipe coating, or as an automotive under-coating sealant or water-proofing material. The oxidized asphalt may be known as “air blown” asphalt. This oxidized asphalt has a higher softening temperature than that of paving asphalts. The oxidized asphalt can be prepared by blowing air to the refinery, at an asphalt processing plant, or at a roofing material plant. The asphalt is heated to about 260° C., and air is bubbled through the asphalt for 1 to 5 hours. When cooled to ambient temperatures, the oxidized asphalt remains in a liquid phase.

As used herein, the term “polymer modified asphalt” generally refers to an asphalt-containing polymer additive derived from classes such as styrene butadiene rubber (SBR) lattices, styrene butadiene styrene (SBS) block copolymers, reactive ethylene terpolymers (RET), ground tire rubber, acrylic lattices, neoprene lattices, ethylene vinyl acetate (EVA) and polybutene.

As used herein, the term “sulfur extended asphalt” generally refers to an asphalt-containing elemental sulfur.

As used herein, the term “rubber modified asphalt” generally refers to an asphalt-containing rubber material, such as a crumb rubber.

As used herein, the term “recycled plastic modified asphalt” generally refers to an asphalt-containing recycled plastic material, such as high-density polyethylene (HDPE), low-density polyethylene (LDPE), polypropylene (PP), polystyrene (PS), polyethylene terephthalate (PET), and polycarbonate.

As used herein, the term “aggregate” refers to a broad category of particulate material used in construction. Aggregates are a component of composite materials such as concrete; the aggregates serve as reinforcement to add strength to the overall composite material. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small exposed pores to irregular with small to large exposed pores. Particle shape and surface texture of both fine and coarse aggregates may influence proportioning of mixtures in such factors as workability, pumpability, fine-to-coarse aggregate ratio, and water requirement.

As used herein, the term “sand” refers to a naturally occurring granular material composed of finely divided rock and mineral particles. It is defined by size in being finer than gravel and coarser than silt. The composition of sand varies, depending on the local rock sources and conditions, but the most common constituent of sand is silica (silicon dioxide, or SiO₂), usually in the form of quartz. In terms of particle size, sand particles range in diameter from about 0.0625 to about 2 millimeters (mm), such as about 0.1 to about 1.8 mm, about 0.3 to about 1.6 mm, about 0.5 to about 1.4 mm, about 0.7 to about 1.2 mm, or about 0.9 to about 1.0 mm. An individual particle in this range is termed a sand grain. Sand grains are between gravel (particles ranging from about 2 mm to about 64 mm) and silt (particles ranging from about 0.004 mm to about 0.0625 mm).

As used herein, limestone refers to a sedimentary rock composed largely of the minerals calcite and aragonite, which are different crystal forms of calcium carbonate (CaCO₃). Limestone is naturally occurring and can be found in skeletal fragments of marine organisms such as coral, forams, and mollusks. Crushed limestone is generated during the crushing and grinding of limestone rocks. The crushed limestone used herein may have an average particle size greater than about 1 mm.

As used herein, the term “vehicle” may include any vehicle with cargo transportation function, such as a truck, a van, a trailer, a semi-trailer, an articulated convoy, or a wagon.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the foregoing, one objective of the present disclosure is to provide petroleum coke in asphalt composition. A second objective of the present disclosure is to provide a method for producing products from the petroleum coke in asphalt composition. A third objective of the present disclosure is to provide a roof coating/water-proof/damp-proofing, and a membrane composition. A fourth objective of the present disclosure is to provide a method of treating a building surface with the roof coating composition.

Provided in the present disclosure are petroleum coke containing asphalt compositions, for utilization in paving, roofing/water proofing and damp proofing applications. By introducing petroleum coke as a filler, its utilization is expanded beyond energy production. More particularly, petroleum coke is incorporated into various materials, including but not limited to, asphalt mix concrete, asphalt roofing, waterproofing, and membrane products, resulting in enhanced performance and durability of these materials. Furthermore, the present disclosure addresses several key challenges, including lowering CO₂ emissions by using petroleum coke as a partial replacement for mineral fillers, thereby reducing CO₂ emissions. It conserves natural resources by replacing aggregates or fillers with petroleum coke and improves the durability and mechanical properties of asphalt mixes, roofing, waterproofing, and damp proofing materials. Additionally, using petroleum coke in asphalt mix can earn carbon credits compared to its use as a fuel, and this method promotes the recycling of waste petroleum coke, contributing to sustainable waste management.

Provided in the present disclosure is an asphalt composition. The asphalt composition of the present disclosure contains a filler, a binder, a fine aggregate (FA), a coarse aggregate (CA), and a petroleum coke. In some embodiments, the asphalt composition contains about 1 to about 15 wt. % filler, about 2 to about 10 wt. % binder, about 20 to about 90 wt. % FA, about 20 to about 90 wt. % CA, and about 0.1 to about 5 wt. % petroleum coke.

In some embodiments, the filler is selected from the group consisting of a cementitious material, a limestone powder material, a pozzolanic material, a lime material, an oil ash material, a recycled plastic material, a rubber material, a fly ash material, a fiber reinforced polymer (FRP) composite material, and mixtures thereof.

In some embodiments, the filler is a cementitious material. In some embodiments, the cementitious material is selected from the group consisting of portland cement, pozzolan cement, gypsum cement, aluminous cement, silica cement, alkaline cement, and cement dust. In further embodiments, the cementitious material is portland cement selected from the group consisting of type I, type II, type III, type, IV, type V, type Ia, IIa, IIIa, and a combination of any two or more types of portland cement. In further embodiments, the cementitious material is a type I ordinary portland cement with a standard specification of ASTM C150 (Standard Specification for Portland Cement, ASTM C150, which is incorporated herein by reference in its entirety).

In some embodiments, the filler is a recycled plastic material. In some embodiments, the recycled plastic material is selected from the group consisting of very low density polyethylene (VLDPE), linear low density polyethylene (LLDPE), low density polyethylene (LDPE), medium density polyethylene (MDPE), high density polyethylene (HDPE), and polycarbonate.

In some embodiments, the filler is a FRP composite material. In some embodiments, the FRP composite material contains a fiber selected from the group consisting of a polypropylene, a polyethylene, an asbestos, a rock wool, a polyester, natural cellulose fibers, mineral fibers, and mixtures thereof.

In some embodiments, the asphalt composition contains a filler in an amount of about 0.5 to about 20 wt. % of the asphalt composition, such as about 1 to about 18 wt. %, about 2 to about 16 wt. %, about 3 to about 14 wt. %, about 4 to about 12 wt. %, about 5 to about 10 wt. %, about 6 to about 8 wt. %, or about 1 wt. %, about 2 wt. %, about 3 wt. %, about 4 wt. %, about 5 wt. %, about 6 wt. %, about 7 wt. %, about 8 wt. %, about 9 wt. % about 10 wt. % about 11 wt. %, about 12 wt. % about 13 wt. % about 14 wt. %, about 15 wt. % about 16 wt. % about 17 wt. % about 18 wt. %, about 19 wt. %, or about 20 wt. % of the asphalt composition. In further embodiments, the asphalt composition contains the filler in the amount of about 3 wt. % of the asphalt composition. In further embodiments, the asphalt composition contains the filler in the amount of about 5 wt. % of the asphalt composition. In further embodiments, the asphalt composition contains the filler in the amount of about 7 wt. % of the asphalt composition. In further embodiments, the asphalt composition contains the filler in the amount of about 9 wt. % of the asphalt composition. In further embodiments, the asphalt composition contains the filler in the amount of about 10 wt. % of the asphalt composition.

In some embodiments, the binder is selected from the group consisting of bitumen, sulfur extended asphalt, polymer modified asphalt, rubber modified asphalt, and recycled plastic modified asphalt. In further embodiments, the binder is bitumen. In further embodiments, the binder is sulfur extended asphalt. In further embodiments, the binder is polymer modified asphalt. In further embodiments, the binder is rubber modified asphalt. In further embodiments, the binder is recycled plastic modified asphalt.

In some embodiments, the asphalt composition contains a binder in an amount of about 1 to about 15 wt. % of the asphalt composition, such as about 2 to about 14 wt. %, about 3 to about 13 wt. %, about 4 to about 12 wt. % about 5 to about 11 wt. %, about 6 to about 10 wt. %, about 7 to about 9 wt. %, or about 2 wt. %, about 3 wt. %, about 4 wt. %, about 5 wt. %, about 6 wt %, about 7 wt. %, about 8 wt. %, about 9 wt. %, about 10 wt. %, about 11 wt. %, about 12 wt. about 13 wt. %, about 14 wt. %, or about 15 wt. % of the asphalt composition. In further embodiments, the asphalt composition contains the binder in the amount of about 5 wt. % of the asphalt composition. In further embodiments, the asphalt composition contains the binder in the amount of about 6 wt. % of the asphalt composition. In further embodiments, the asphalt composition contains the binder in the amount of about 7 wt. % of the asphalt composition.

The fine aggregate may include, but is not limited to, sand (e.g., dune sand), crushed stone, crushed rock, crushed shells, or other crushed/pulverized/ground material, for example, crushed/pulverized/ground forms of concrete, gravel, rocks, natural soil, quarried crushed mineral aggregates from igneous (granite, syenite, diorite, gabbro peridotite pegmatite, volcanic glass, felsite, basalt), metamorphic (marble, metaquartzite, slate, phyllite, schist, amphibolite, hornfels, gneiss, serpentite) or sedimentary rocks (conglomerate, sandstone, claystone, siltstone, argillite, shale, limestone, dolomite, marl, chalk, chert), including unused and waste aggregates from quarry operations, dredged aggregates, china clay stent, china clay wastes, natural stone, recycled bituminous pavements, recycled concrete pavements, reclaimed road base and subbase materials, crushed bricks, construction and demolition wastes, crushed glass, slate waste, waste plastics, egg shells, sea shells, barite, limonite, magnetite, ilmenite, hematite, iron, steel, including recycled or scrap steel, and mixtures thereof. In some embodiments, the FA has a specific gravity of about 2.2 to about 2.8, and a standard specification of ASTM C128 (Standard Test Method for Relative Density (Specific Gravity) and Absorption of Fine Aggregate, ASTM C128, which is incorporated herein by reference in its entirety). In some embodiments, the fine aggregate has an average particle size of about 0.3 to about 1 mm, such as about 0.4 to about 0.8 mm, about 0.5 to about 0.6 mm. Fine aggregates with average particle sizes slightly above or below these values may also function as intended. The grading of fine aggregate employed herein conforms to the standard ASTM C33/C33M-18 (Standard Specification for Concrete Aggregates, ASTM C33/C33M-18, which is incorporated herein by reference in its entirety). In some embodiments, the fine aggregate is sand.

In some embodiments, the FA is sand.

In some embodiments, the asphalt composition contains a fine aggregate in an amount of about 10 to about 90 wt. % of the asphalt composition, such as about 20 to about 90 wt. %, about 25 to about 85 wt. %, about 30 to about 80 wt. %, about 35 to about 75 wt. %, about 40 to about 70 wt. %, about 45 to about 65 wt. %, about 50 to about 60 wt. %, or about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. % of the asphalt composition. In further embodiments, the asphalt composition contains the FA in the amount of about 20 wt. % of the asphalt composition. In further embodiments, the asphalt composition contains the FA in the amount of about 40 wt. % of the asphalt composition. In further embodiments, the asphalt composition contains the FA in the amount of about 60 wt. % of the asphalt composition. In further embodiments, the asphalt composition contains the FA in the amount of about 80 wt. % of the asphalt composition. In further embodiments, the asphalt composition contains the FA in the amount of about 90 wt. % of the asphalt composition.

In some embodiments, the CA is selected from the group consisting of crushed stone, crushed gravel, and mixtures thereof.

In some embodiments, the asphalt composition contains a coarse aggregate (CA) in an amount of about 10 to about 90 wt. % of the asphalt composition, such as about 20 to about 90 wt. %, about 25 to about 85 wt. %, about 30 to about 80 wt. %, about 35 to about 75 wt. %, about 40 to about 70 wt. %, about 45 to about 65 wt. %, about 50 to about 60 wt. %, or about 10 wt. 00 about 15 wt. %, about 20 wt. %, about 25 wt. %, about 30 wt. %, about 35 wt. %, about 40 wt. 00 about 45 wt. %, about 50 wt. %, about 55 wt. %, about 60 wt. %, about 65 wt. %, about 70 wt. 00 about 75 wt. %, about 80 wt. %, about 85 wt. %, or about 90 wt. % of the asphalt composition. In further embodiments, the asphalt composition contains the CA in the amount of about 20 wt. % of the asphalt composition. In further embodiments, the asphalt composition contains the CA in the amount of about 40 wt. % of the asphalt composition. In further embodiments, the asphalt composition contains the CA in the amount of about 60 wt. % of the asphalt composition. In further embodiments, the asphalt composition contains the CA in the amount of about 80 wt. % of the asphalt composition. In further embodiments, the asphalt composition contains the CA in the amount of about 90 wt. % of the asphalt composition.

In some embodiments, the coarse aggregate used herein has an average particle size in a range of about 2 to about 20 mm, such as about 4 to about 15 mm, about 6 to about 13 mm, or about 8 to about 12 mm. In some embodiments, the coarse aggregate used herein has a specific gravity of about 2.0 to about 3.0, about 2.2 to about 2.9, about 2.4 to about 2.8, about 2.5 to about 2.7. In some embodiments, the coarse aggregate present in the asphalt composition is crushed limestone. In some embodiments, the crushed limestone has an average particle size of about 1.5 to about 32 mm, such as about 2 to about 30 mm, about 4 to about 28 mm, about 6 to about 24 mm, about 8 to about 20 mm, about 10 to about 18 mm, or about 12 to about 16 mm. The crushed limestone may contain materials including, but not limited to, calcium carbonate, silicon dioxide, quartz, feldspar, clay minerals, pyrite, siderite, chert and other minerals. The grading of coarse aggregate employed herein conforms to the standard ASTM C33/C33M-18.

In some embodiments, the asphalt composition contains a petroleum coke in an amount of about 0.01 to about 10 wt. % of the asphalt composition, such as about 0.05 to about 9 wt. %, about 0.1 to about 8 wt. %, about 0.5 to about 7 wt. %, about 0.8 to about 6 wt. %, about 1 to about 5 wt. %, about 1.1 to about 4 wt. %, about 1.4 to about 3 wt. %, about 1.7 to about 2 wt. %, or about 0.01 wt. %, about 0.05 wt. %, about 0.1 wt. %, about 0.3 wt. %, about 0.5 wt. %, about 0.7 wt. %, about 0.9 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, or about 2.0 wt. % of the asphalt composition. In further embodiments, the asphalt composition contains the petroleum coke in the amount of about 1 wt. % of the asphalt composition. In further embodiments, the asphalt composition contains the petroleum coke in the amount of about 1.2 wt. % of the asphalt composition. In further embodiments, the asphalt composition contains the petroleum coke in the amount of about 1.4 wt. % of the asphalt composition. In further embodiments, the asphalt composition contains the petroleum coke in the amount of about 1.6 wt. % of the asphalt composition. In further embodiments, the asphalt composition contains the petroleum coke in the amount of about 1.8 wt. % of the asphalt composition. In further embodiments, the asphalt composition contains the petroleum coke in the amount of about 2.0 wt. % of the asphalt composition.

In some embodiments, the petroleum coke has a particle size in a range of about 0.1 micrometers (μm) to 50 mm, such as about 1 μm to about 45 mm, about 3 μm to about 40 mm, about 5 μm to about 35 mm, about 7 μm to about 30 mm, about 9 μm to about 25 mm, about 11 μm to about 20 mm, about 13 μm to about 15 mm, about 15 μm to about 10 mm, about 17 μm to about 5 mm, about 19 μm to about 1 mm, about 21 μm to about 800 μm, about 23 μm to about 600 μm, about 25 μm to about 400 μm, about 27 μm to about 200 μm, about 29 μm to about 100 μm, about 31 μm to about 80 μm, about 33 μm to about 60 μm, about 35 μm to about 40 μm, or about 2 μm, about 4 μm, about 8 μm, about 16 μm, about 32 μm, about 64 μm, about 128 μm, about 256 μm, about 512 μm about 1 mm, about 2 mm, about 4 mm, about 8 mm, about 16 mm, about 32 mm, or about 48 mm. In further embodiments, the petroleum coke has a particle size of about 5 μm to about 10 mm. In further embodiments, the petroleum coke has a particle size of about 10 μm to about 5 mm. In further embodiments, the petroleum coke has a particle size of about 20 μm to about 1 mm. In further embodiments, the petroleum coke has a particle size of about 25 μm to about 500 μm. In further embodiments, the petroleum coke has a particle size of about 30 μm to about 100 μm. In further embodiments, the petroleum coke has a particle size of about 35 μm to about 50 μm.

In some embodiments, the petroleum coke has a particle size at 80% cumulative passing (D80) of equal to or less than about 80 μm, such as equal to or less than about 75 μm, equal to or less than about 70 μm, equal to or less than about 65 μm, equal to or less than about 60 μm, equal to or less than about 55 μm, equal to or less than about 50 μm, equal to or less than 45 μm, equal to or less than about 40 μm, equal to or less than about 35 μm, equal to or less than about 30 μm, equal to or less than about 25 μm, equal to or less than about 20 μm, equal to or less than about 15 μm, or equal to or less than about 10 μm. In further embodiments, the petroleum coke has a D80 of equal to or less than about 75 μm. In further embodiments, the petroleum coke has a D80 of equal to or less than about 65 μm. In further embodiments, the petroleum coke has a D80 of equal to or less than about 55 μm. In further embodiments, the petroleum coke has a D80 of equal to or less than about 45 μm. In further embodiments, the petroleum coke has a D80 of equal to or less than about 35 μm.

In some embodiments, petroleum coke contains uniform shape particles. The uniform shape particles include, but are not limited to, spherical particles, cylindrical particles, cubical particles, cuboidal particles, pentagonal particles, hexagonal particles, and rhombic particles. In some embodiments, petroleum coke particles contain non-uniform shape particles. The grading of petroleum coke employed herein conforms to the standard ASTM C33/C33M-18.

In some embodiments, the petroleum coke contains about 80 to about 95 wt. % of carbon, about 0.1 to about 10 wt. % of sulfur, about 2 to about 5 wt. % of hydrogen, about 0.1 to about 1 wt. % of nitrogen, about 0.1 to about 10 wt. % of moisture, about 0.1 to about 5 wt. % of ash, about 0.1 to about 10 wt. % of two or more volatile organic compounds, and 0.1 to about 5 wt. % of two or more metals. The element content of the petroleum coke is determined by energy-dispersive X-ray (EDX) analysis. In some embodiments, the EDX analysis is conducted to by applying a petroleum coke on a copper-covered stump to form a copper-covered sample. The copper-covered sample is used to ensure proper analysis and high quality, and the image is magnified a million times.

In some embodiments, the petroleum coke contains about 80 to about 95 wt. % of carbon, such as about 82 to about 93 wt. % of carbon, about 84 to about 91 wt. % of carbon, about 86 to about 89 wt. % of carbon, about 87 to about 88 wt. % of carbon, or about 81 wt. % of carbon, about 83 wt. % of carbon, about 85 wt. % of carbon, about 87 wt. % of carbon, about 89 wt. % of carbon, about 91 wt. % of carbon, about 93 wt. % of carbon, or about 95 wt. % of carbon, as determined by EDX analysis. In some embodiments, the petroleum coke contains about 0.1 to about 10 wt. % of sulfur, such as about 0.5 to about 9 wt. % of sulfur, about 1 to about 8 wt. % of sulfur, about 2 to about 7 wt. % of sulfur, about 3 to about 6 wt. % of sulfur, about 4 to about 5 wt. % of sulfur, or about 0.1 wt. % of sulfur, about 0.8 wt. % of sulfur, about 1.5 wt. % of sulfur, about 2.5 wt. % of sulfur, about 3.5 wt. % of sulfur, about 4.5 wt. % of sulfur, about 5.5 wt. % of sulfur, about 6.5 wt. % of sulfur, about 7.5 wt. % of sulfur, about 8.5 wt. % of sulfur, or about 9.5 wt. % of sulfur, as determined by EDX analysis. In some embodiments, the petroleum coke contains about 2 to 5 wt. % of hydrogen, such as about 2.3 to about 4.7 wt. % of hydrogen, about 2.6 to about 4.4 wt. % of hydrogen, about 2.9 to about 4.1 wt. % of hydrogen, about 3.2 to about 3.8 wt. % of hydrogen, or about 2.2 wt. % of hydrogen, about 2.6 wt. % of hydrogen, about 3.0 wt. % of hydrogen, about 3.4 wt. % of hydrogen, about 3.8 wt. % of hydrogen, about 4.2 wt. % of hydrogen, about 4.6 wt. % of hydrogen, or about 5.0 wt. % of hydrogen, as determined by EDX analysis. In some embodiments, the petroleum coke contains about 0.1 to 1 wt. % of nitrogen, such as about 0.2 to about 0.9 wt. % of nitrogen, about 0.3 to about 0.8 wt. % of nitrogen, about 0.4 to about 0.7 wt. % of nitrogen, about 0.5 to about 0.6 wt. % of nitrogen, or about 0.15 wt. % of nitrogen, about 0.25 wt. % of nitrogen, about 0.35 wt. % of nitrogen, about 0.45 wt. % of nitrogen, about 0.55 wt. % of nitrogen, about 0.65 wt. % of nitrogen, about 0.75 wt. % of nitrogen, about 0.85 wt. % of nitrogen, or about 0.95 wt. % of nitrogen, as determined by EDX analysis. In some embodiments, the petroleum coke contains about 0.1 to about 10 wt. % of moisture, such as about 0.5 to about 9 wt. % of moisture, about 1 to about 8 wt. % of moisture, about 2 to about 7 wt. % of moisture, about 3 to about 6 wt. % of moisture, about 4 to about 5 wt. % of moisture, or about 0.1 wt. % of moisture, about 0.8 wt. % of moisture, about 1.5 wt. % of moisture, about 2.5 wt. % of moisture, about 3.5 wt. % of moisture, about 4.5 wt. % of moisture, about 5.5 wt. % of moisture, about 6.5 wt. % of moisture, about 7.5 wt. % of moisture, about 8.5 wt. % of moisture, or about 9.5 wt. % of moisture. In some embodiments, the petroleum coke contains about 0.1 to 5 wt. % of ash, such as about 0.5 to about 4.5 wt. % of ash, about 1 to about 4 wt. % of ash, about 1.5 to about 3.5 wt. % of ash, about 2 to about 3 wt. % of ash, or about 0.1 wt. % of ash, about 0.8 wt. % of ash, about 1.5 wt. % of ash, about 2.5 wt. % of ash, about 3.5 wt. % of ash, about 4.5 wt. % of ash, or about 5.0 wt. % of ash. In some embodiments, the petroleum coke contains about 0.1 to 10 wt. % of two or more volatile organic compounds, such as about 0.5 to about 9 wt. % of two or more volatile organic compounds, about 1 to about 8 wt. % of two or more volatile organic compounds, about 2 to about 7 wt. % of two or more volatile organic compounds, about 3 to about 6 wt. % of two or more volatile organic compounds, about 4 to about 5 wt. % of two or more volatile organic compounds, or about 0.1 wt. % of two or more volatile organic compounds, about 0.8 wt. % of two or more volatile organic compounds, about 1.5 wt. % of two or more volatile organic compounds, about 2.5 wt. % of two or more volatile organic compounds, about 3.5 wt. % of two or more volatile organic compounds, about 4.5 wt. % of two or more volatile organic compounds, about 5.5 wt. % of two or more volatile organic compounds, about 6.5 wt. % of two or more volatile organic compounds, about 7.5 wt. % of two or more volatile organic compounds, about 8.5 wt. % of two or more volatile organic compounds, or about 9.5 wt. % of two or more volatile organic compounds. In some embodiments, the petroleum coke contains about 0.1 to 5 wt. % of two or more metals, such as about 0.5 to about 4.5 wt. % of two or more metals, about 1 to about 4 wt. % of two or more metals, about 1.5 to about 3.5 wt. % of two or more metals, about 2 to about 3 wt. % of two or more metals, or about 0.1 wt. % of two or more metals, about 0.8 wt. % of two or more metals, about 1.5 wt. % of two or more metals, about 2.5 wt. % of two or more metals, about 3.5 wt. % of two or more metals, about 4.5 wt. % of two or more metals, or about 5.0 wt. % of two or more metals.

In some embodiments, the two or more volatile organic compounds are selected from the group consisting of benzene, toluene, phenol, styrene, xylene, cresol, and combinations thereof. In some embodiments, the two or more metals are selected from the group consisting of aluminum, calcium, chromium, cobalt, iron, manganese, magnesium, molybdenum, nickel, potassium, sodium, titanium, vanadium, copper, zinc, lead, tin, silver, gold, platinum, palladium, beryllium, and cadmium.

In some embodiments, the petroleum coke has a density in a range of about 1 to about 1.7 kilograms per cubic meter (kg/m³), such as about 1.1 to about 1.6 kg/m³, about 1.2 to about 1.5 kg/m³, about 1.3 to about 1.4 kg/m³, or about 1.1 kg/m³, about 1.2 kg/m³, about 1.3 kg/m³, about 1.4 kg/m³, about 1.5 kg/m³, about 1.6 kg/m³, or about 1.7 kg/m³. In further embodiments, the petroleum coke has a density of about 1.1 kg/m³. In further embodiments, the petroleum coke has a density of about 1.3 kg/m³. In further embodiments, the petroleum coke has a density of about 1.5 kg/m³. In further embodiments, the petroleum coke has a density of about 1.7 kg/m³.

In some embodiments, the petroleum coke has a Mohs hardness in a range of about 3 to about 10, such as about 4 to 9, about 5 to 8, about 6 to 7, or about 3.5, about 4.5, about 5.5, about 6.5, about 7.5, or about 8.5. In further embodiments, the petroleum coke has a Mohs hardness of about 5. In further embodiments, the petroleum coke has a Mohs hardness of about 6. In further embodiments, the petroleum coke has a Mohs hardness of about 7. In further embodiments, the petroleum coke has a Mohs hardness of about 8.

In some embodiments, the asphalt composition further contains one or more of an anti-stripping agent, an anti-rutting agent, an antioxidant, a stabilizer, an adhesion promoter, and a polymer modifier. In some embodiments, the anti-stripping agent is selected from the group consisting of a polyphosphoric acid, an amine based anti-stripping agent, a phosphoric ester based anti-stripping agent, and mixtures thereof. In some embodiments, the anti-rutting agent is selected from the group consisting of a polyethylene, an ethylene vinyl acetate, a polybutene, a high-impact polystyrene, a polypropylene, and mixtures thereof. In some embodiments, the antioxidant is selected from the group consisting of a bisphenol based antioxidant, a monophenol based antioxidant, a sulfur based antioxidant, and mixtures thereof. In some embodiments, the stabilizer is selected from the group consisting of an acrylic polyol resin, a non-yellowing polyurea resin, a polyisocyanate, and mixtures thereof. In some embodiments, the adhesion promoter is selected from the group consisting of a hydroxyethyl acryloyl phosphate, a hydroxyethyl methacrylate phosphate, and mixtures thereof. In some embodiments, the polymer modifier is selected from the group consisting of styrene-isoprene-styrene (SIS), styrene-butadiene-styrene (SBS), ethylene vinyl acetate (EVA), and mixtures thereof.

In some embodiments, the asphalt composition further contains a fiber selected from the group consisting of a polypropylene, a polyethylene, an asbestos, a rock wool, a polyester, natural cellulose fibers, mineral fibers, and mixtures thereof.

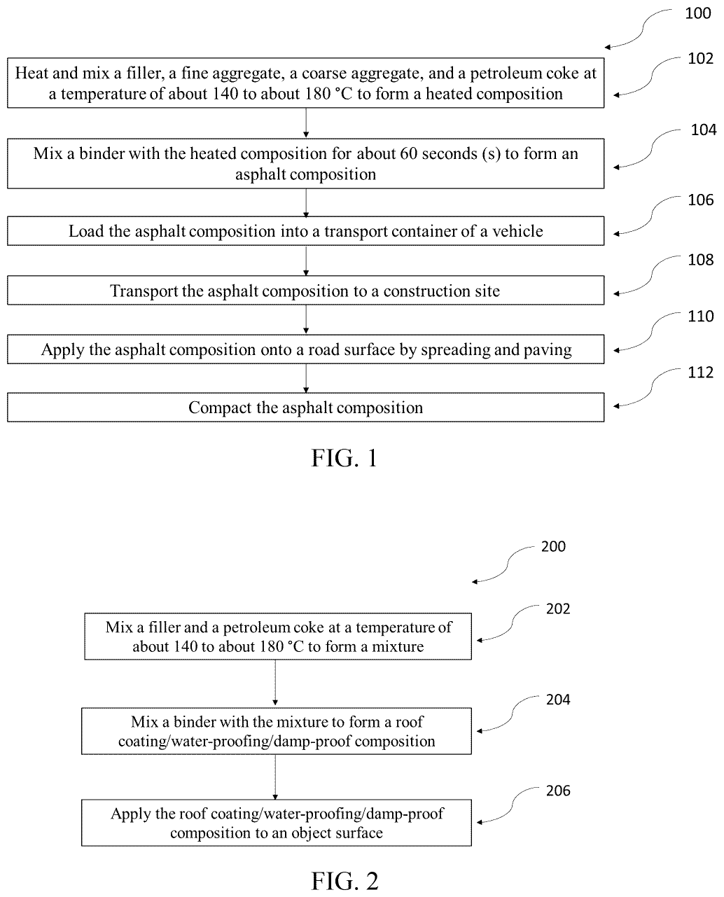

Referring to FIG. 1, a method (100) for paving a surface using an asphalt composition is provided. In some embodiments, the surface is a road surface.

At step 102, the method (100) includes forming an asphalt composition by mixing and heating a filler, a FA, a CA, and a petroleum coke for about 2 to about 120 minutes, such as about 10 to about 100 minutes, about 20 to about 80 minutes, about 30 to about 60 minutes, or about 5 minutes, about 15 minutes, about 25 minutes, about 35 minutes, about 45 minutes, or about 55 minutes. The mixing may be performed in a heated condition in an asphalt mixing device at a temperature of about 140 to about 180° C., such as about 145 to about 175° C., about 150 to about 170° C., about 155 to about 165° C., or about 160° C. to form a heated composition.

At step 104, the method (100) includes mixing a binder with the heating composition for about 60 seconds (s) to form the asphalt composition. In some embodiments, the binder is mixed with the heated composition for about 10 to 300 s, such as about 20 to 250 s, about 30 200 s, about 40 to about 150 s, about 50 to about 100 s, or about 60 s.

At step 106, the method (100) includes load the asphalt composition into a transport container of a vehicle. The vehicle has a cargo transportation function, In some embodiments, the vehicle includes, but is not limited to, a truck, a van, a trailer, a semi-trailer, an articulated convoy, or a wagon.

At step 106, the method (100) includes transporting the asphalt composition to a construction site.

At step 108, the method (100) includes applying the asphalt composition onto a road surface by spreading and paving. In some embodiments, the applying is performed by spreading the asphalt composition to cover at least a portion of the surface.

At step 110, the method (100) includes compacting the asphalt composition. In some embodiments, the compacting the asphalt composition is performed by applying a pressure onto the asphalt composition applied.

Also provided in the present disclosure is a roof coating/water-proofing/damp-proof composition. In some embodiments, the roof coating of the present disclosure contains a filler, a binder, and a petroleum coke. In some embodiments, the roof coating contains about 0.01 to about 60 wt. % filler, about 40 to about 90 wt. % binder, and about 2 to about 65 wt. % petroleum coke.

The roof coating composition contains a filler in an amount of about 0.01 to about 60 wt. % of the roof coating composition, such as about 0.1 to about 55 wt. %, about 1 to about 50 wt. %, about 10 to about 45 wt. %, about 20 to about 40 wt. %, about 30 to about 35 wt. %, or about 0.05 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, or about 60 wt. % of the roof coating composition.

The roof coating composition contains a binder in an amount of about 40 to about 95 wt. % of the roof coating composition, such as about 45 to about 90 wt. %, about 50 to about 85 wt. %, about 55 to about 80 wt. %, about 60 to about 75 wt. %, about 65 to about 70 wt. %, or about 43 wt. %, about 46 wt. %, about 49 wt. %, about 52 wt. %, about 55 wt. %, about 58 wt. %, about 61 wt. %, about 64 wt. %, about 67 wt. %, about 70 wt. %, about 73 wt. %, about 76 wt. %, about 79 wt. %, about 82 wt. %, about 85 wt. %, or about 88 wt. % of the roof coating composition.

The roof coating composition contains a petroleum coke in an amount of about 2 to about 65 wt. % of the roof coating composition, such as about 5 to about 60 wt. %, about 10 to about 55 wt. %, about 15 to about 50 wt. %, about 20 to about 45 wt. %, about 25 to about 40 wt. %, about 30 to about 35 wt. %, or about 7 wt. %, about 12 wt. %, about 17 wt. %, about 22 wt. %, about 27 wt. %, about 32 wt. %, about 37 wt. %, about 42 wt. %, about 47 wt. %, about 52 wt. %, about 57 wt. %, or about 62 wt. % of the roof coating composition. The grading of petroleum coke employed herein conforms to the standard ASTM C33/C33M-18.

The roof coating composition further contains one or more of an anti-stripping agent, an anti-rutting agent, an antioxidant, a stabilizer, an adhesion promoter, and a polymer modifier. In some embodiments, the anti-stripping agent is present in the roof coating composition in an amount of about 0.01 to about 10 wt. %, such as about 0.5 to about 9 wt. %, about 1 to about 8 wt. %, about 2 to about 7 wt. %, about 3 to about 6 wt. %, or about 4 to about 5 wt. %, or about 0.05 wt. %, about 0.5 wt. %, about 1.5 wt. %, about 2.5 wt. %, about 3.5 wt. %, about 4.5 wt. %, about 5.5 wt. %, about 6.5 wt. %, about 7.5 wt. %, about 8.5 wt. %, or about 9.5 wt. %. In some embodiments, the anti-rutting agent is present in the roof coating composition in an amount of about 0.01 to about 10 wt. %, such as about 0.5 to about 9 wt. %, about 1 to about 8 wt. %, about 2 to about 7 wt. %, about 3 to about 6 wt. %, or about 4 to about 5 wt. %, or about 0.05 wt. %, about 0.5 wt. %, about 1.5 wt. %, about 2.5 wt. %, about 3.5 wt. %, about 4.5 wt. %, about 5.5 wt. %, about 6.5 wt. %, about 7.5 wt. %, about 8.5 wt. %, or about 9.5 wt. %. In some embodiments, the polymer modifier is present in the roof coating composition in an amount of about 0.01 to about 10 wt. %, such as about 0.5 to about 9 wt. %, about 1 to about 8 wt. %, about 2 to about 7 wt. %, about 3 to about 6 wt. %, or about 4 to about 5 wt. %, or about 0.05 wt. %, about 0.5 wt. %, about 1.5 wt. %, about 2.5 wt. %, about 3.5 wt. %, about 4.5 wt. %, about 5.5 wt. %, about 6.5 wt. %, about 7.5 wt. %, about 8.5 wt. %, or about 9.5 wt. %. In some embodiments, the antioxidant is present in the roof coating composition in an amount of about 0.01 to about 5 wt. %, such as about 0.5 to about 4.5 wt. %, about 1 to about 4 wt. %, about 1.5 to about 3.5 wt. %, about 2 to about 3 wt. %, or about 2.5 to about 3 wt. %, or about 0.05 wt. %, about 0.5 wt. %, about 1.5 wt. %, about 2 wt. %, about 2.5 wt. %, about 3 wt. %, about 3.5 wt. %, about 4 wt. %, about 4.5 wt. %, or about 5 wt. %. In some embodiments, the stabilizer is present in the roof coating composition in an amount of about 0.01 to about 5 wt. %, such as about 0.5 to about 4.5 wt. %, about 1 to about 4 wt. %, about 1.5 to about 3.5 wt. %, about 2 to about 3 wt. %, or about 2.5 to about 3 wt. %, or about 0.05 wt. %, about 0.5 wt. %, about 1.5 wt. %, about 2 wt. %, about 2.5 wt. %, about 3 wt. %, about 3.5 wt. %, about 4 wt. %, about 4.5 wt. %, or about 5 wt. %. In some embodiments, the adhesion promoter is present in the roof coating composition in an amount of about 0.01 to about 5 wt. %, such as about 0.5 to about 4.5 wt. %, about 1 to about 4 wt. %, about 1.5 to about 3.5 wt. %, about 2 to about 3 wt. %, or about 2.5 to about 3 wt. %, or about 0.05 wt. %, about 0.5 wt. %, about 1.5 wt. %, about 2 wt. %, about 2.5 wt. %, about 3 wt. %, about 3.5 wt. %, about 4 wt. %, about 4.5 wt. %, or about 5 wt. %.

Referring to FIG. 2, a method (200) of treating a building surface is provided.

At step 202, the method (200) includes forming a roof coating composition by heating and mixing a filler and a petroleum coke for about 2 to about 120 minutes, such as about 10 to about 100 minutes, about 20 to about 80 minutes, about 30 to about 60 minutes, or about 5 minutes, about 15 minutes, about 25 minutes, about 35 minutes, about 45 minutes, or about 55 minutes at a temperature of about 140 to about 180° C., such as about 145 to about 175° C., about 150 to about 170° C., about 155 to about 165° C., or about 160° C. to form a mixture.

At step 204, the method (200) includes mixing a binder with the mixture to form a roof coating composition.

At step 206, the method (200) includes applying the roof coating composition to an object surface. The roof coating composition is applied to the object surface via a brushing tool.

In some embodiments, the object surface is a roof surface. In some embodiments, the roof surface is made of at least one material selected from the group consisting of an asphalt-based material, a clay-based material, a metal-based material, a wood-based material, a cementitious material, and a polymer-based material.

In some embodiments, a water-proofing and/or a damp-proof composition can be prepared by following the method (200).

In some embodiments, the roof coating/water-proofing/damp-proofing composition is a hot mix that include only the binder, such as bitumen, and the filler. In some embodiments, the filler is the petroleum coke or a partial replacement of a filler, such as calcium carbonate and/or cement, with the petroleum coke.

In some embodiments, a roofing product made from the roof coating/water-proofing/damp-proofing composition is made in the form of a membrane that can be fixed to a surface with one or more adhesive materials or with one or more mechanical fixing mechanisms.

In some embodiments, the roofing product is made as a shingle in the presence of a framework.

### EXAMPLES

The following examples demonstrate asphalt compositions and roof coating compositions, methods of producing cured specimens from the asphalt compositions, and methods of treating an object surface as described herein. The examples are provided solely for illustration and are not to be construed as limitations of the present disclosure, as many variations thereof are possible without departing from the spirit and scope of the present disclosure.

### Materials

Binders include, but are not limited to, bitumen, sulfur extended asphalt, polymer modified asphalt, rubber modified asphalt, recycled plastic modified asphalt.

Fillers include, but are not limited to, a cementitious material, a limestone powder material, a pozzolanic material, a lime material, an oil ash material, a recycled plastic material, a rubber material, a fly ash material, an oil ash material, a bag house dust material, a black carbon material, and a fiber reinforced polymer (FRP) composite material.

Other materials used in the asphalt compositions and roof coating compositions include, but are not limited to, recycled plastic, fibers, rubber, construction waste, polymers, sulfur, rubber, modifiers.

Recycled plastics include, but are not limited to, very low density polyethylene (VLDPE), linear low density polyethylene (LLDPE), low density polyethylene (LDPE), medium density polyethylene (MDPE), high density polyethylene (HDPE), and polycarbonate. The polycarbonate may be obtained from electronic wastes.

Fibers include, but are not limited to, polypropylene, polyethylene, or other types of fibers.

Petroleum coke may be used as a partial and/or a total replacement of the filler in asphalt compositions and roof coating compositions, respectively. Additionally, the petroleum coke may be used as a partial replacement of the aggregate in asphalt compositions.

The chemical composition of the petroleum coke is shown in Table 1.

TABLE 1
Chemical composition of the petroleum coke

| Component | Weight % |
|---|---|
| Carbon | 80 to 95 |
| Sulfur | 0.1 to 10 |
| Remaining elements | 0.1 to 15 |

The physical properties of the petroleum coke are shown in Table 2.

TABLE 2
Physical properties of the petroleum coke

| Property | Standard |
|---|---|
| Particle sizes | Less than 0.1 mm to 50 mm |
| Density | 1 to 1.7 kg/m³ |
| Color | Black, gray, and/or golden brown |
| Hardness | 5 to 8 MOH |

The particle/grain sizes of petroleum coke are shown in Table 3.

TABLE 3
Particle/grain sizes of the petroleum coke

| Application | Particle/grain size |
|---|---|
| Partial/total Replacement of filler | 80% of the pet coke is smaller |
| in asphalt mix or filler of the | than 45 μm |
| proofing, water proofing and | (passing number 325 Sieves) |
| damp proofing materials | |
| Aggregates in asphalt mix | Final aggregate mix meets ASTM |
| | C33 for coarse and fine aggregates |
| | when used as filler. 80% of the pet |
| | coke is smaller than 45 μm (passing |
| | number 325 Sieves) |

### Example 1: Preparation of the Asphalt Composition

The petroleum coke was first grinded until 80% of the petroleum coke particles were smaller than 45 μm. The asphalt composition was prepared according to Table 4. The asphalt composition ingredients are heated at a temperature of about 140 to about 180° C. then mixed until a homogeneous mixture was achieved. The asphalt composition can be prepared using any known agitation method known to those of ordinary skill in the art, for example, via stirring, blending, or mixing for any amount of time needed to achieve the homogeneous mixture.

TABLE 4
Concrete Composition

| Component | Weight % |
|---|---|
| Binder | 5 to 7 |
| Aggregates | 80 to 90 |
| Filler | 3 to 10 |
| Petroleum coke | 1 to 2 |

### Example 2: Preparation of the Cured Specimen

The asphalt composition was prepared according to Example 1. The asphalt composition was stirred homogeneously at slow speed for at least 3 minutes using a mixer with single or double mixing paddle. The asphalt composition was then introduced into a mold to form a molded composition. The mold containing the molded composition was dried at ambient conditions of room temperature and atmospheric pressure for about 48 hours to form the cured specimen. Alternatively the mixed ingredients are transported then spread and compacted for road construction.

### Example 3: Testing of the Cured Specimen

Specimens prepared according to Example 2 are examined to assess their mechanical and thermal properties as well as durability characteristics.

### Example 4: Preparation of the Roof Coating Composition

A roof coating composition was prepared according to Table 5. The petroleum coke was first grinded until 80% of the petroleum coke particles were smaller than 45 m. The roof coating composition was heated then mixed until a homogeneous mixture was achieved. The roof coating composition can be prepared using any known agitation method known to those of ordinary skill in the art, for example, via stirring, blending, or mixing for any amount of time needed to achieve the homogeneous mixture. A water-proofing and/or a damp-proof composition can be prepared according to Example 4 by following the same procedure.

TABLE 5
Roof coating composition

| Component | Weight % |
|---|---|
| Binder | 40 to 95 |
| Filler | 0 to 60 |
| Petroleum coke | 5 to 60 |

### Example 5: Characterization of the Roof Coating Composition

The roof coating composition prepared according to Example 4 is examined according to ASTM D4586 standard test method (Standard Specification for Asphalt Roof Cement, Asbestos-Free, ASTM D4586/D4586M-07, which is incorporated herein by reference in its entirety).

### Example 6: Object Surface Treatment

The roof coating composition was prepared according to Example 4. The roof coating composition was stirred homogeneously at slow speed for at least 15 minutes using a mixer with single or double mixing paddle. The roof coating composition was then applied to an object surface via a brushing tool. The object surface was a roof surface.

### Example 7: Other Petroleum Coke-Containing Compositions

Other petroleum coke-containing compositions were prepared according to Table 5 for use in damp proofing and waterproofing applications. The petroleum coke-containing compositions are examined according to ASTM D449/D449M-03 standard test method (Standard Specification for Asphalt Used in Dampproofing and Waterproofing, ASTM D449/D449M-03, which is incorporated herein by reference in its entirety).

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

Embodiment 1: An asphalt composition, comprising:
a filler in an amount of about 1 to about 15 wt. % of the asphalt composition;
a binder in an amount of about 2 to about 10 wt. % of the asphalt composition;
a fine aggregate (FA) in an amount of about 20 to about 90 wt. % of the asphalt composition;
a coarse aggregate (CA) in an amount of about 20 to about 90 wt. % of the asphalt composition; and
a petroleum coke in an amount of about 0.1 to about 5 wt. % of the asphalt composition.

Embodiment 2: The asphalt composition of embodiment 1, wherein the petroleum coke has a particle size in a range of about 0.1 micrometers (μm) to about 50 millimeters (mm).

Embodiment 3: The asphalt composition of embodiment 1 or 2, wherein the petroleum coke has a particle size at 80% cumulative passing (D80) of equal to or less than about 45 μm.

Embodiment 4: The asphalt composition of any one of embodiments 1-3, wherein the petroleum coke comprises about 80 to 95 wt. % of carbon, about 0.1 to 10 wt. % of sulfur, about 2 to 5 wt. % of hydrogen, about 0.1 to 1 wt. % of nitrogen, about 0.1 to 10 wt. % of moisture, about 0.1 to 5 wt. % of ash, about 0.1 to 10 wt. % of two or more volatile organic compounds, and 0.1 to 5 wt. % of two or more metals.

Embodiment 5: The asphalt composition of any one of embodiments 1-4, wherein the two or more metals are selected from the group consisting of aluminum, calcium, chromium, cobalt, iron, manganese, magnesium, molybdenum, nickel, potassium, sodium, titanium, vanadium, copper, zinc, lead, tin, silver, gold, platinum, palladium, beryllium, and cadmium.

Embodiment 6: The asphalt composition of any one of embodiments 1-5, wherein the petroleum coke has a density in a range of about 1 to about 1.7 kilograms per cubic meter (kg/m³), and a Mohs hardness in a range of about 5 to about 8.

Embodiment 7: The asphalt composition of any one of embodiments 1-6, wherein the filler is selected from the group consisting of a cementitious material, a limestone powder material, a pozzolanic material, a lime material, an oil ash material, a recycled plastic material, a rubber material, a fly ash material, a fiber reinforced polymer (FRP) composite material, and mixtures thereof.

Embodiment 8: The asphalt composition of any one of embodiments 1-7, wherein the cementitious material is selected from the group consisting of portland cement, pozzolan cement, gypsum cement, aluminous cement, silica cement, alkaline cement, and cement dust.

Embodiment 9: The asphalt composition of any one of embodiments 1-8, wherein the recycled plastic material is selected from the group consisting of very low density polyethylene (VLDPE), linear low density polyethylene (LLDPE), low density polyethylene (LDPE), medium density polyethylene (MDPE), high density polyethylene (HDPE), and polycarbonate.

Embodiment 10: The asphalt composition of any one of embodiments 1-9, wherein the FRP composite material comprises a fiber selected from the group consisting of a polypropylene, a polyethylene, an asbestos, a rock wool, a polyester, natural cellulose fibers, mineral fibers, and mixtures thereof.

Embodiment 11: The asphalt composition of any one of embodiments 1-10, wherein the binder is selected from the group consisting of bitumen, sulfur extended asphalt, polymer modified asphalt, rubber modified asphalt, and recycled plastic modified asphalt.

Embodiment 12: The asphalt composition of any one of embodiments 1-11, wherein the FA is sand.

Embodiment 13: The asphalt composition of any one of embodiments 1-12, wherein the CA is selected from the group consisting of crushed stone, crushed gravel, and mixtures thereof.

Embodiment 14: The asphalt composition of any one of embodiments 1-13, further comprising one or more of an anti-stripping agent, an anti-rutting agent, an antioxidant, a stabilizer, an adhesion promoter, and a polymer modifier.

Embodiment 15: A method of paving a surface, the method comprising:
heating and mixing a filler, a fine aggregate, a coarse aggregate, and a petroleum coke at a temperature of about 140 to about 180° C. to form a heated composition;
mixing a binder with the heated composition for about 60 seconds (s) to form the asphalt composition of embodiment 1;
applying the asphalt composition onto the surface; and
compacting the asphalt composition applied.

Embodiment 16: A roof coating composition, comprising:
a filler in an amount of about 0.01 to about 60 wt. % of the roof coating composition;
a binder in an amount of about 40 to about 95 wt. % of the roof coating composition; and
a petroleum coke in an amount of about 2 to about 65 wt. % of the roof coating composition.

Embodiment 17: The roof coating composition of embodiment 16, further comprising one or more of about 0.01 to about 10 wt. % of an anti-stripping agent, about 0.01 to about 10 wt. % of an anti-rutting agent, about 0.01 to about 5 wt. % of an antioxidant, about 0.01 to about 5 wt. % of a stabilizer, about 0.01 to about 5 wt. % of an adhesion promoter, and about 0.01 to about 10 wt. % of a polymer modifier.

Embodiment 18: A method of treating an object surface, the method comprising:
mixing and heating a filler and a petroleum coke at a temperature of about 140 to about 180° C. to form a mixture;
mixing a binder with the mixture to form the roof coating composition of embodiment 16; and
applying the roof coating composition to the object surface.

Embodiment 19: The method of embodiment 18, wherein the object surface is a roof surface, and wherein the roof surface is made of at least one material selected from the group consisting of an asphalt-based material, a clay-based material, a metal-based material, a wood-based material, a cementitious material, and a polymer-based material.

1. An asphalt composition, comprising:
a filler in an amount of about 1 to about 15 wt. % of the asphalt composition;
a binder in an amount of about 2 to about 10 wt. % of the asphalt composition;
a fine aggregate (FA) in an amount of about 20 to about 90 wt. % of the asphalt composition;
a coarse aggregate (CA) in an amount of about 20 to about 90 wt. % of the asphalt composition; and
a petroleum coke in an amount of about 0.1 to about 5 wt. % of the asphalt composition.

2. The asphalt composition of claim 1, wherein the petroleum coke has a particle size in a range of about 0.1 micrometers (μm) to about 50 millimeters (mm).

3. The asphalt composition of claim 2, wherein the petroleum coke has a particle size at 80% cumulative passing (D80) of equal to or less than about 45 μm.

4. The asphalt composition of claim 1, wherein the petroleum coke comprises about 80 to 95 wt. % of carbon, about 0.1 to 10 wt. % of sulfur, about 2 to 5 wt. % of hydrogen, about 0.1 to 1 wt. % of nitrogen, about 0.1 to 10 wt. % of moisture, about 0.1 to 5 wt. % of ash, about 0.1 to 10 wt. % of two or more volatile organic compounds, and 0.1 to 5 wt. % of two or more metals.

5. The asphalt composition of claim 4, wherein the two or more metals are selected from the group consisting of aluminum, calcium, chromium, cobalt, iron, manganese, magnesium, molybdenum, nickel, potassium, sodium, titanium, vanadium, copper, zinc, lead, tin, silver, gold, platinum, palladium, beryllium, and cadmium.

6. The asphalt composition of claim 1, wherein the petroleum coke has a density in a range of about 1 to about 1.7 kilograms per cubic meter (kg/m³), and a Mohs hardness in a range of about 5 to about 8.

7. The asphalt composition of claim 1, wherein the filler is selected from the group consisting of a cementitious material, a limestone powder material, a pozzolanic material, a lime material, an oil ash material, a recycled plastic material, a rubber material, a fly ash material, a fiber reinforced polymer (FRP) composite material, and mixtures thereof.

8. The asphalt composition of claim 7, wherein the cementitious material is selected from the group consisting of portland cement, pozzolan cement, gypsum cement, aluminous cement, silica cement, alkaline cement, and cement dust.

9. The asphalt composition of claim 7, wherein the recycled plastic material is selected from the group consisting of very low density polyethylene (VLDPE), linear low density polyethylene (LLDPE), low density polyethylene (LDPE), medium density polyethylene (MDPE), high density polyethylene (HDPE), and polycarbonate.

10. The asphalt composition of claim 7, wherein the FRP composite material comprises a fiber selected from the group consisting of a polypropylene, a polyethylene, an asbestos, a rock wool, a polyester, natural cellulose fibers, mineral fibers, and mixtures thereof.

11. The asphalt composition of claim 1, wherein the binder is selected from the group consisting of bitumen, sulfur extended asphalt, polymer modified asphalt, rubber modified asphalt, and recycled plastic modified asphalt.

12. The asphalt composition of claim 1, wherein the FA is sand.

13. The asphalt composition of claim 1, wherein the CA is selected from the group consisting of crushed stone, crushed gravel, and mixtures thereof.

14. The asphalt composition of claim 1, further comprising one or more of an anti-stripping agent, an anti-rutting agent, an antioxidant, a stabilizer, an adhesion promoter, and a polymer modifier.

15. A method of paving a surface, the method comprising:
heating and mixing a filler, a fine aggregate, a coarse aggregate, and a petroleum coke at a temperature of about 140 to about 180° C. to form a heated composition;
mixing a binder with the heated composition for about 60 seconds (s) to form the asphalt composition of claim 1;
applying the asphalt composition onto the surface; and
compacting the asphalt composition applied.

16. A roof coating composition, comprising:
a filler in an amount of about 0.01 to about 60 wt. % of the roof coating composition;
a binder in an amount of about 40 to about 95 wt. % of the roof coating composition; and
a petroleum coke in an amount of about 2 to about 65 wt. % of the roof coating composition.

17. The roof coating composition of claim 16, further comprising one or more of about 0.01 to about 10 wt. % of an anti-stripping agent, about 0.01 to about 10 wt. % of an anti-rutting agent, about 0.01 to about 5 wt. % of an antioxidant, about 0.01 to about 5 wt. % of a stabilizer, about 0.01 to about 5 wt. % of an adhesion promoter, and about 0.01 to about 10 wt. % of a polymer modifier.

18. A method of treating an object surface, the method comprising:
mixing and heating a filler and a petroleum coke at a temperature of about 140 to about 180° C. to form a mixture;
mixing a binder with the mixture to form the roof coating composition of claim 16; and
applying the roof coating composition to the object surface.

19. The method of claim 18, wherein the object surface is a roof surface, and wherein the roof surface is made of at least one material selected from the group consisting of an asphalt-based material, a clay-based material, a metal-based material, a wood-based material, a cementitious material, and a polymer-based material.
